(19) United States
(12) Patent Application Publication
(10) Pub. No.: US 2025/0114256 A1
(43) Pub. Date: Apr. 10, 2025

(54) ACCESS SYSTEM WITH OVERRUN PROTECTION

(71) Applicant: Bode - Die Tür GmbH, Kassel (DE)

(72) Inventors: Ulrich Arend, Dickershausen (DE); Marco Cimmino, Adelebsen (DE); Christoph Theis, Bad Wildungen (DE); Torben Kunzemann, Naumburg (DE)

(21) Appl. No.: 18/905,492

(22) Filed: Oct. 3, 2024

(30) Foreign Application Priority Data
Oct. 6, 2023 (DE) 10 2023 127 279.9

(51) Int. Cl. A61G 3/06; B61D 23/02

(52) U.S. Cl. CPC A61G 3/061; B61D 23/02

(57) ABSTRACT

A vehicle access system includes
a step plate extendible in an ejection unit with a walk-on upper side and bottom side facing a subsurface in the extended state, and in which is aligned horizontally in a sliding step position and inclined to the horizontal in a ramp position;
a sensor configured whereby an area in front of the access system is measured in terms of relative position to the step plate and measurement data is generated, based upon which the step plate is moved into sliding step or ramp positions; and
an overrun protection element on the bottom side and swivel-mounted with a front surface arranged at its free end at the front in the extension direction and vertically arranged in the swiveled out position and with a floor surface facing away from, and parallel to the main extension plane of the bottom side in the swiveled out position.

### CROSS-REFERENCE TO RELATED APPLICATIONS

This application claims the benefit of German patent application no. 10 2023 127 279.9, filed on Oct. 6, 2023, the contents of which are incorporated herein by reference in their entirety.

### TECHNICAL FIELD

The present disclosure relates to an access system, in particular for a rail vehicle, comprising a linearly extendible step plate with a walk-on top.

Such a step plate arranged in a linearly displaceable manner can be displaced along a displacement axis while performing a displacement movement from a retracted position to an extended position and vice versa.

In the present case, a “vehicle” can be understood in particular as a wheeled or rail vehicle. In this context, rail vehicles can likewise involve transport vehicles for public transportation, for example streetcars, suburban trains, trains (regional trains, long-distance trains), subways, trams, etc. However, access devices can basically be used in vehicles of any kind, in which a height difference or a gap between a stopping platform and a tread surface inside of the vehicle must be overcome during entry or egress. For example, such a situation can also arise when a bus or airplane stops at a gate or stopping platform of the gate, which is why use can also be made of access systems in airplanes.

### BACKGROUND

Sliding step systems are based upon moving a step plate back and forth between a retracted and an extended position, in particular along a displacement axis extending in the transverse direction of the vehicle. In the extended position, the step plate provides a tread surface which a person can use to enter or exit the vehicle. In order to ensure such a linear displacement of the step plate, the step plate can be guided in a vehicle-side housing or a framework in a linearly displaceable manner by means of a guide. Sliding steps make it easier to enter and exit a vehicle by bridging a gap present between the vehicle and a stopping platform (e.g., a platform edge).

Also known apart from sliding steps are ramps, which are likewise used in the area of doors, for example of rail vehicles. A ramp on the doors of trains is a device that was developed to ease in particular the barrier-free access for people with limited mobility. It allows wheelchair users, older people and other individuals with walking restrictions to comfortably get on and off trains without having to overcome steps. The precise function of a ramp on train doors can vary depending on the design and manufacturer. However, a ramp is basically used essentially to overcome a height difference. A gentle angle of inclination allows wheelchair users to roll over the ramp without great deal of effort, for example. Passengers with limited mobility can thus use such a ramp to get on or off the train. Wheelchair users can comfortably drive up and down the ramp without having to depend on stairs or steps.

Independently of the help provided to passengers with limited mobility, ramps are also used by healthy passengers, for example instead of steps, to bridge height differences.

Because of the different requirements, it is often necessary that vehicles provide both types of access aids. Alternatively, vehicles having only one of the two types can only be used on routes where only this one type, i.e., a ramp or a sliding step, is needed.

Sliding steps often have sensors that measure the distance to the platform and determine and control the necessary travel path of the sliding step. A problem arises when the sensors do not function properly or have failed, for example. For example, this can result in a step plate above a platform being extended too far over the gap, i.e., crossing the platform. If the step plate remains standing over the platform and the vehicle is lowered as the result of loading, the step plate sits up in the worst case scenario, and can no longer be retracted.

Sliding steps are designed for significantly higher loads, and have a shorter travel time than ramps. As a rule, ramps are very slow, and only designed for smaller loads. In addition, ramps do not have an automatic mode or overrun protection lever, since they cannot ascertain the platform position. Therefore, conventional ramps are operated by the train personnel directly at the entry, which is expensive.

The present disclosure creates an improved access system. The access system is to be capable of reliably bridging gaps and height differences. Nonetheless, manufacturing and maintenance costs are to be as low as possible. In particular, the access system is to be able to reliably detect whether a sliding step or a ramp is required given a failure of the sensors. Furthermore, the disclosure proposes a method for bridging gaps and height differences with the help of a suitable access system.

In order to achieve this, an access system for a vehicle with the features recited in the claims is provided. The method according to the disclosure has the procedural steps of the independent method claim. Furthermore, the advantage is achieved by providing a step plate arrangement with the features in the claims.

The access system is capable of independently deciding whether a ramp or sliding step is locally required. For this purpose, the at least one sensor of a sensor system, but preferably several sensors, initially measures an area in front of the access system, in particular a platform, in its relative position to the step plate. The sensor system recognizes whether a gap and/or a height difference must be overcome. A computer processor in the sensor system is used to determine whether a ramp or sliding step is required, and the corresponding command is relayed to the control device and the drive unit, so that the sliding step is moved accordingly.

In particular, the position of the platform can be determined via the sensors without contact and a decision can be made about the mode even while extending the step plate in the sliding step mode. If the sliding step position is required, the tread step is stopped at the set distance to the platform. If it is detected that the ramp position is required and possible, the step plate is shifted into the ramp mode and lowered by a kinematic system until it rests on the subsurface or platform.

As a consequence, the disclosure combines the advantages of a sliding step with those of a ramp. According to the disclosure, then, the step plate is constructed in such a way that its load capacity is sufficient for both functions; it can also be completely loaded in the sliding step position. Short cycle times are realizable, and the system is also able to register that platforms might not even be reachable at all, which would result in safety risks and potentially also damages.

One essential point of the disclosure lies in the fact that the overrun protection element according to the disclosure provides a redundance for detection, for example of platforms that are too close. Even if sensors are missing or have failed, the overrun protection lever ensures that the platform will not be overrun.

The at least one overrun protection lever is arranged on the bottom side of the step plate, and swivel-mounted in relation to the bottom side. Its free end at the front in the extension direction, which swivels out of the bottom side, has an essentially vertically arranged front contact surface. The latter enables a bumping against an obstacle, for example a platform in the sliding step mode.

If the front contact surface bumps against an obstacle, this acts directly on the drive motor of the step plate, and the torque increases. This change is registered, and can be used to stop the step plate during its extension movement or even retract it, for example.

Furthermore, the side of the overrun protection element facing away from the bottom side of the step plate has a floor contact surface aligned essentially parallel to the main extension plane of the bottom side. The overrun protection element can rest on the subsurface with the latter.

In a particularly advantageous embodiment variant, the floor contact surface is designed as a sliding element, so that the latter can slide more easily on the subsurface in the ramp position.

If the sliding plate is lowered further toward the subsurface and contacts the latter, the overrun protection element is pressed back into its initial position, until it is preferably again arranged largely inside of an outer contour of the stepping element, with only the floor contact surface protruding slightly toward the subsurface relative to the bottom side. The step plate does not get jammed. The geometry of the free end of the overrun protection element is thus adjusted to the geometry of the step plate edge, as a result of which the ramp can be extended further after placement, and pushed over the platform.

In an especially advantageous embodiment variant, the overrun protection element itself can have sensors, for example which register the position and/or the swivel degree. For example, a sensor which takes gyroscopic measurements is conceivable.

In an especially advantageous embodiment variant, the overrun protection element is designed as a curved lever, the free end of which is designed to run upwardly toward the bottom side of the step plate. The arc formed at the free end comprises the front contact surface, which is adjoined by the floor contact surface during the further progression of the lever. The other free end of the lever is swivel-mounted to the bottom side of the step plate. The position of the lever is here preferably selected in such a way that its free end roughly closes with the free end of the step plate at the front in the extension direction when swiveled in, i.e., when the step plate rests on the subsurface. The free end of the lever can also be arranged several centimeters behind the free edge of the step plate in relation to the free end of the step plate.

While a single lever is basically sufficient, it is also possible to use two or more levers or overrun protection elements.

The method according to the disclosure for bridging a gap and/or a height difference in front of an entry area of a vehicle is characterized by the following procedural steps:
Extending the step plate and swiveling out the overrun protection element, wherein the extension movement is stopped when the front contact surface contacts a resistance, and the step plate is then used as a sliding step, or
Extending the step plate up to a specific extension distance and swiveling out the overrun protection element, then lowering the step plate on a subsurface while simultaneously swiveling in the overrun protection and using the step plate as a ramp.

The previously determined extension distance is normally based upon the previously measured data of the sensor device. The step plate is thus extended until the gap has been bridged. However, the previously determined extension distance can also initially be an intermediate position in which the step plate already rests on a subsurface in its ramp position, but is subsequently moved further or even retracted.

The disclosure will be described in more detail based on the following figures. The latter show:

Additional advantageous configurations of an access device according to the disclosure arise from the features indicated in the subclaims as well as those described below.

### BRIEF DESCRIPTION OF THE DRAWINGS

Additional features and advantages of the disclosure arise from the following description of an exemplary embodiment of the disclosure not to be understood as limiting, which will be described in more detail below with reference to the drawings. Schematically shown in this drawing are:

FIG. 1 a simplified side view of an exemplary embodiment of a step plate according to the disclosure in a first sliding step position,

FIG. 2 a simplified side view of an exemplary embodiment of a step plate according to the disclosure in a second sliding step position,

FIG. 3 a simplified side view of an exemplary embodiment of a step plate according to the disclosure in an intermediate position, and

FIG. 4 a simplified side view of an exemplary embodiment of a step plate according to the disclosure in a ramp position.

### DETAILED DESCRIPTION OF THE DRAWINGS

An access system according to the disclosure comprises a step plate arrangement arranged in a linearly displaceable manner, which consists of a step plate 20 and an ejection unit (not shown) effectively connected with the step plate 20. As a person enters or exits, the step plate 20 is tread-loaded, i.e., exposed to the weight force of the person. A drive unit (not shown) can be used to move the step plate 20 along a displacement axis from a retracted position to an extended position and vice versa.

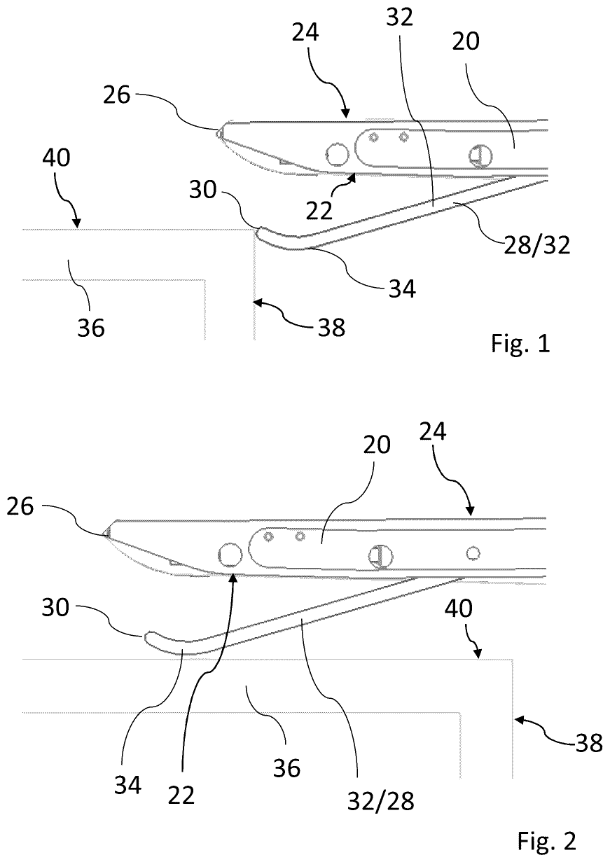

FIGS. 1 to 4 show a bottom side 22, a walk-on upper side 24 and a free edge 26 of the step plate 20 that is free in the extension direction. Likewise visible is an overrun element 28 arranged on the bottom side of the step plate 20 and swivel-mounted in relation to the bottom side 22, with a free end at the front in the extension direction which forms a front contact surface 30.

In the exemplary embodiment shown, the overrun protection element 28 is designed as a lever 32, the free end 30 of which is shaped like an arc, wherein the arc extends in the direction of the bottom side 22, meaning that the free end 30 faces roughly in the direction of the bottom side 22. The side of the arc-shaped end area of the overrun protection element 30 facing away from the bottom side 22 forms a floor contact surface 34 in the exemplary embodiment shown.

FIG. 1 shows the step plate 20 in an extended state, with the swivel-mounted lever 32 swiveled downwards. Further discernible is a platform 36 underneath the step plate 20. The free end or the front contact surface 30 of the overrun protection element 28 contacts a vertical section 38 of the platform 36. If the step plate 20 were to be extended further, its movement would be stopped by the overrun protection element 28. The resistance against the drive of the step plate 20 changes as a result. This change is registered based upon the changing torque, and the extension movement is stopped.

FIG. 2 shows the position of the step plate 20 regionally above the platform 36, wherein the floor contact surface 34 of the lever 32 rests on a horizontal surface 40 of the platform 36.

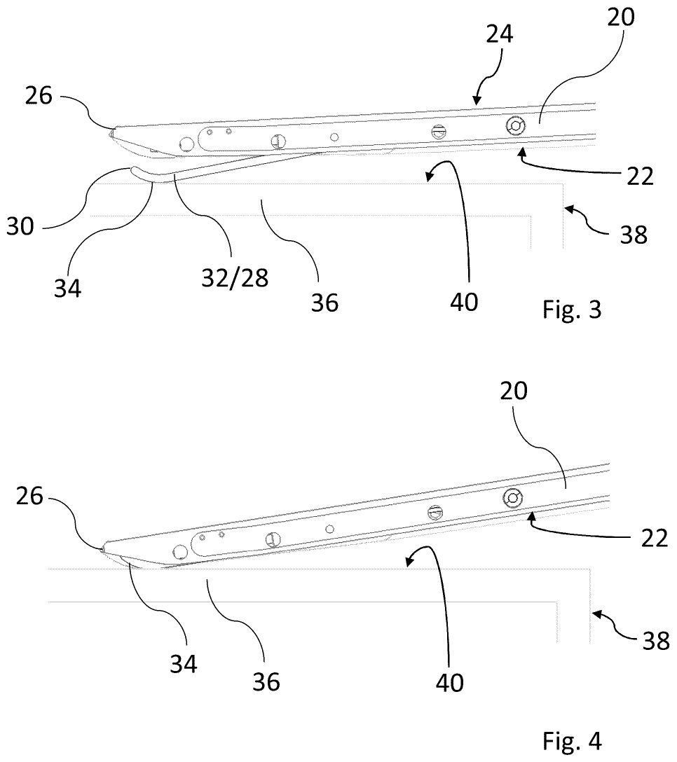

FIGS. 3 and 4 illustrate the movement or lowering of the step plate 20 onto the horizontal surface 40 of the platform 36 in the ramp position. FIG. 3 shows an intermediate position, in which the lever 32 was already pressed away a little toward the bottom side 22 by the horizontal surface 40. On FIG. 4, the lever 32 is then located almost completely inside of the outer contour of the step plate 20; it is fully swiveled in. In this position, only the floor contact surface 34 is in contact with the horizontal surface 40 of the platform 36. If the step plate 20 is now extended further or even moved back, the floor contact surface 34 preferably designed as a sliding element now slides on the horizontal surface 40.

The figures only show a single preferred exemplary embodiment. Also conceivable are deviating forms of the lever 32 or even the arrangement of several levers 32, for example.

The invention claimed is:

1. An access system for a vehicle, preferably a rail vehicle comprising, having:
a step plate linearly extendible in an ejection unit with a walk-on upper side and a bottom side that faces a subsurface in the extended state, and in the extended state is aligned essentially horizontally in a first walk-on sliding step position and inclined to the horizontal in a second walk-on ramp position;
a sensor system with at least one sensor, which is designed and arranged in such a way that an area in front of the access system can be measured in terms of its relative position to the step plate and measurement data can be generated, based upon which the step plate is moved into a sliding step position or a ramp position; and
an overrun protection element arranged on the bottom side of the step plate and swivel-mounted in relation to the bottom side with a front contact surface arranged at its free end located at the front in the extension direction and essentially vertically arranged in the swiveled out position and with a floor contact surface facing away from the bottom side and aligned essentially parallel to the main extension plane of the bottom side in the swiveled out position, wherein the overrun protection element is mounted on the bottom side in such a way as to swivel out while extending the sliding step.

2. The access system according to claim 1, wherein in the swiveled-out state of the overrun protection element, the front contact surface is arranged in an area of a free edge of the step plate located at the front in the extension direction.

3. The access system according to claim 1, wherein the front free edge of the step plate is arranged 1 cm to 10 cm in front of the front contact surface in the extension direction in the swiveled-out state of the overrun protection element.

4. The access system according to claim 1, wherein the overrun protection element is arc-shaped in the area of the floor contact surface, wherein a free end located at the front in the extension direction is curved in design toward the bottom side of the step plate.

5. The access system according to claim 1, wherein the floor contact surface is formed out of a slidable material with a low friction coefficient.

6. The access system according to claim 1, wherein the free end of the overrun protection element located at the front in the extension direction is adjusted in design to the geometry of the edge of the step plate located at the front in the extension direction in such a way that, in the swiveled-in state, the overrun protection element is essentially arranged inside of an outer contour of the step plate, and only the floor contact surface protrudes relative to the outer contour.

7. The access system according to claim 1, wherein the overrun protection element is designed as a lever, which with its end located at the rear in the extension direction of the step plate is swivel-mounted on the bottom side of the step plate.

8. A step plate arrangement with a step plate for an access system comprising:
a walk-on upper side and a bottom side that faces a subsurface in the extended state of the step plate; and
an overrun protection element arranged on the bottom side of the step plate and swivel-mounted in relation to the bottom side, with a floor contact surface arranged on its free end located in front in the extension direction and essentially vertically arranged in the swiveled-out state, and a floor contact surface aligned essentially parallel to the main extension plane of the bottom side on its side facing away from the bottom side in the swiveled-out state,
wherein the overrun protection element is mounted on the bottom side of the step plate in such a way as to swivel out during the extension of the step plate, and the step plate in the extended state is aligned essentially horizontally in a first walk-on sliding step position and inclined to the horizontal in a second walk-on ramp position.

9. A method for bridging a gap and/or a height difference in front of an entry area of a vehicle, wherein the vehicle has an access system with the features of claim 1, the method including the following steps:
Extending the step plate and swiveling out the overrun protection element, wherein the extension movement is stopped when the front contact surface contacts a resistance, and then using the step plate as a sliding step, or
Extending the step plate up to a specific extension distance and swiveling out the overrun protection element, and then lowering the step plate onto a subsurface while simultaneously swiveling in the overrun protection element and using the step plate as a ramp.

10. The method according to claim 9, wherein the determined extension distance corresponds to a maximum extension distance of the step plate.

11. The method according to claim 10, wherein the determined extension distance corresponds to an intermediate position between a fully retracted position and the maximum extension distance of the step plate, and that the step plate is moved while the floor contact surface contacts the subsurface.

12. The method according to claim 10, wherein the overrun protection element is connected with a drive of the step plate, a contact between the front contact surface and a resistance produces a change in the torque of the drive, and the change in torque is used as a signal for ending the extension movement.
